(19) United States
(12) Patent Application Publication
(10) Pub. No.: US 2007/0226933 A1
(43) Pub. Date: Oct. 4, 2007

(54) YARN FOR CAR WASH BRUSHES

(75) Inventors: Ezio Moretti, Lainate MI (IT); Graziano Rachelli, Cicognara MN (IT)

Correspondence Address: LUCAS & MERCANTI, LLP, 475 PARK AVENUE SOUTH, 15TH FLOOR, NEW YORK, NY, 10016, US

(73) Assignees: MORE & WASH S.R.L., Lainate MI (IT); RACHELLI ARISTIDE S.R.L., Cicognara MN (IT)

(21) Appl. No.: 11/674,397

(22) Filed: Feb. 13, 2007

(30) Foreign Application Priority Data
Mar. 28, 2006 (IT) MI2006A 000578

(51) Int. Cl. B60S 3/06

(52) U.S. Cl. 15/207.2; 15/230; 15/53.1; 15/97.3

(57) ABSTRACT

A yarn (F) for car wash brushes includes and end portion (R) that is tapered down to a thin size smaller than 0.25 mm so that it is soft and does not retain dirt, whereby the cleaning effectiveness of the brushes made with this type of yarn remains unchanged over time and there are no risks of damaging the paint due to dirty ends. Moreover, it is possible to have yarns smaller than 1 mm made of polyester or nylon, that have greater cleaning effectiveness, are more delicate on the paint and last up to 5 times more with respect to conventionally used materials.

### FIELD OF THE INVENTION

The present invention relates to apparatuses for the automatic wash of vehicles, and in particular to a new type of yarn for the brushes used in said apparatuses as well as to a brush made with said yarn.

### BACKGROUND OF THE INVENTION

It is known that in apparatuses for the automatic wash of vehicles there are used brushes consisting of rotating rollers along which yarns are arranged that thanks to the rotational movement of the roller, combined with the presence of water and detergent, perform the wash of the vehicles. The yarns used for said brushes have to meet different conflicting requirements in order to achieve satisfying results as to wash effectiveness, protection of the washed vehicles and functionality of the apparatus. More specifically, the yarns must be made such that they resist the working conditions, do not damage the vehicle paint, do not get entangled and last as much as possible for obvious cost reasons.

On the basis of these requirements, conventionally used yarns are made of polyethylene with a diameter of 1-1.5 mm and with the end portion that is frayed or fringed to make it soft (so-called “feathering”). The working of the end portion is intended to prevent a “whip effect” when the yarn during its rotation hits the body of the vehicle, while the minimum value of the diameter is defined by entanglement problems that occur with this material at smaller diameters. It is important to prevent these problems in order not to risk damaging the vehicle that is being washed, because if entangled yarns hook up onto projecting elements of the vehicle (e.g. wing mirror, windshield wiper) the traction exerted by them as a consequence of the rotation of the brush might cause the detachment of said elements.

Other materials such as polyesters allow to reach diameters smaller than 1 mm without entanglement problems, but since they are too hard for feathering the end portion they must be additivated with weakening substances to allow said working, with the result that also the endurance of the yarns is dramatically reduced.

Regardless of the material, the same frayed shape of the end portion causes various drawbacks since dust and dirt particles removed from the vehicle body tend to remain trapped inside the end portion, without being ejected due to the effect of the centrifugal force caused by the rotation of the brush.

As a consequence, not only the cleaning effectiveness of the brushes drops rapidly, but when the dirty ends of the yarns hit the body they cause scratches and opacity of the paint. Moreover, algae colonies tend to settle in the feathered ends due to the micro-environment that remains damp for a long time, and therefore it is also difficult to clean property the brushes to restore their cleaning effectiveness.

### SUMMARY OF THE INVENTION

Therefore the object of the present invention is to provide a yarn which overcomes the above-mentioned drawbacks.

This object is achieved by means of a yarn having an end portion tapered down to a size smaller than 0.25 mm. Other advantageous features are disclosed in the dependent claims.

A first fundamental advantage of the present yarn is that it does not retain dirt, since the dust particles are not hindered by the feathered end and therefore can easily be ejected by the centrifugal force during the rotation of the brush. As a consequence, the cleaning effectiveness of the brushes made with this type of yarn remains unchanged over time, and there are no risks of damaging the paint due to dirty ends.

A second significant advantage of this yarn stems from the fact that it can be made with materials having a greater endurance such as polyesters or nylon, since the tapering operation can be easily carried out even on said materials without adding weakening additives. As a consequence, it is possible to have yarns smaller than 1 mm that have greater cleaning effectiveness, are more delicate on the paint and last up to 5 times more with respect to conventionally used materials.

Still another advantage of this yarn results from the lack of build-up of dirt and/or algae at the ends, whereby it is possible to dispense with the brush cleaning treatments to restore the cleaning effectiveness thereof, since the latter is substantially constant throughout the operating life of the brush.

These and other advantages and characteristics of the yarn according to the present invention will be clear to those skilled in the art from the following detailed description of an embodiment thereof, with reference to the annexed drawings.

### BRIEF DESCRIPTION OF THE DRAWINGS

FIG. 1 is a partial diagrammatic view of a prior art yarn; and

FIG. 2 is a partial diagrammatic view of a yarn according to the invention.

### DETAILED DESCRIPTION OF THE INVENTION

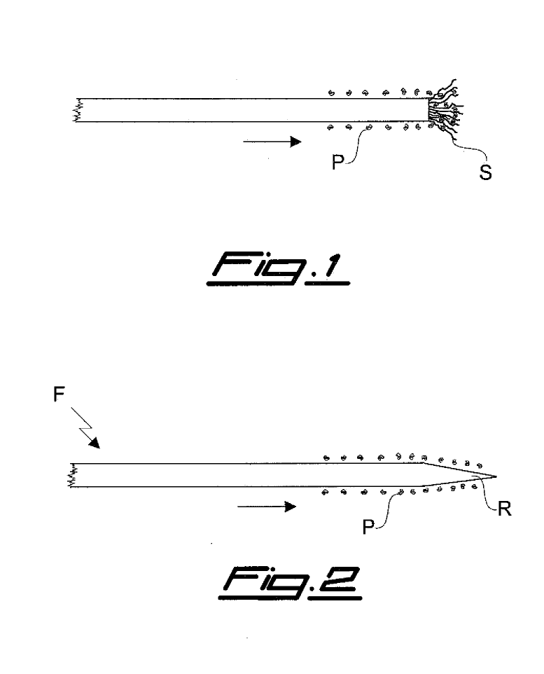

With reference to said figures there is seen that in the conventional yarn of FIG. 1 the frayed end portion S is an obstacle to the ejection of the dust particles P that tend to slide along the yarn due to the effect of the centrifugal force. On the contrary, in the novel yarn F of the present invention the tapered end portion R is not an obstacle to the ejection of the dust particles P, which therefore do not accumulate at end R.

The tapering operation of yarn F can be made either in a mechanical manner through abrasion or in a chemical manner through controlled erosion, namely by dipping the yarn ends into a corrosive substance and then taking them out progressively so as to obtain an end R with a substantially conical profile.

As mentioned above, the preferred materials for this novel type of yarn are polyesters and nylon for the good performance that they have even at small sizes, for the good behavior in contact with detergents and for the fact that they do not retain dirt and do not get soaked by water. Obviously, nothing prevents the use of other materials that might be advantageous for specific applications, as long as the useful tapered shape of end R is maintained.

In particular, the yarn is preferably made with a circular cross-section having a diameter between 0.30 and 0.90 mm, while end R is made thin to a size smaller than 0.25 mm so as to obtain a portion that is sufficiently soft to clean the body without any risk of damaging the paint. However, other shapes of the cross-section are possible, depending on the extrusion or spinning die used in manufacturing the yarn.

The length of end R is preferably between 5 and 60 mm, since a length shorter than 5 mm would not allow to achieve a suitable softness, whereas a length longer than 60 mm begins to imply risks of mutual entanglement of the ends, because their diameter is very small and ideally reaches zero.

It should be noted that the above-mentioned values are meant as average values of the plurality of yarns applied on a brush, since the yarn working processes (extrusion/spinning and mechanical/chemical tapering) do not allow to achieve an extremely precise size control.

It is therefore clear that the above-described and illustrated embodiment of the yarn according to the invention is just an example susceptible of various modifications. Possible additions can thus be made to the yarn of the present invention, yet without departing from the scope of protection of the invention as defined by the appended claims.

1. Yarn (F) for car wash brushes, characterized in that it includes and end portion (R) that is tapered down to a thin size smaller than 0.25 mm.

2. Yarn (F) according to claim 1, characterized in that the tapered end portion (R) has a length between 5 and 60 mm.

3. Yarn (F) according to claim 1 or 2, characterized in that has a circular cross-section with a diameter between 0.30 and 0.90 mm.

4. Yarn (F) according to claim 3, characterized in that it is made of polyester.

5. Yarn (F) according to claim 3, characterized in that it is made of nylon.

6. Car wash brush, characterized in that it is made with a yarn (F) according to claim 1.

7. Method for the production of a yarn (F) according to claim 1, characterized in that the step of tapering the end portion (R) is carried out through mechanical abrasion or through controlled chemical erosion.
